(19) United States
(12) Patent Application Publication
(10) Pub. No.: US 2014/0069219 A1
(43) Pub. Date: Mar. 13, 2014

(54) REDUCTION GEAR FOR ELECTRIC POWER STEERING AND METHOD FOR MANUFACTURING THE SAME

(71) Applicant: Mando Corporation, Pyeongtaek-si (KR)

(72) Inventor: Hee Chul AHN, Yongin-si (KR)

(73) Assignee: MANDO CORPORATION, Pyeongtaek-si (KR)

(21) Appl. No.: 14/024,538

(22) Filed: Sep. 11, 2013

(30) Foreign Application Priority Data
Sep. 11, 2012 (KR) 10-2012-0100358

(51) Int. Cl. F16H 55/06; B29D 15/00

(52) U.S. Cl. CPC F16H 55/06; B29D 15/00
USPC 74/412 R; 264/328.16

(57) ABSTRACT

A reduction gear for electric power steering includes a first reduction gear composition for electric power steering containing 95 to 97 parts by weight of polyamide 66 (PA66) among polyamide-based materials, and a second reduction gear composition for electric power steering containing 3 to 5 parts by weight of an ethylene-methacrylic acid copolymer (EMAA) among polyolefin-based materials, wherein a weight ratio of the PA66 to the EMAA is 24:1 to 49:1.

A method for manufacturing a reduction gear for electric power steering includes adding a first reduction gear composition for electric power steering comprising 95 to 97 parts by weight of PA66 among polyamide-based materials and a second reduction gear composition for electric power steering containing 3 to 5 parts by weight of an EMAA among polyolefin-based materials to a heater having a melting temperature of 250° C. to 260° C. for 2 to 3 minutes, to prepare a mix composition containing the PA66 and the EMAA in a weight ratio of 24:1 to 49:1, injecting a material including the mix composition using an injector at 270° C. to 280° C., and cooling the injected material including the mix composition at room temperature.

### CROSS-REFERENCE TO RELATED APPLICATION

This application claims the benefit of Korean Patent Application No. P2012-0100358, filed on Sep. 11, 2012, in the Korean Intellectual Property Office, the disclosure of which is incorporated herein by reference.

### BACKGROUND

1. Field

Embodiments of the present invention relate to a reduction gear for electric power steering and a method for manufacturing the same.

2. Description of the Related Art

In general, a reduction gear including a worm gear made of stainless steel and a worm wheel gear made of a plastic is predominantly used in an electric power steering.

The reduction gear rotates a steering column by amplifying a rotational force generated by an electric motor in proportion to speed-reduction ratios of the worm gear and the worm wheel gear, and thereby helps handling of a driver manipulate a steering wheel connected to the steering column.

Monomer cast (MC) nylon containing no reinforcing agent, and PA6, PA66, PA46 and PA612 materials containing glass fiber having a diameter of 6 to 15 μm as a reinforcing agent are predominantly used as resins for worm wheel gears, in consideration of wear resistance, fatigue resistance, dimensional stability, and manufacturing costs. However, PA-based materials absorb excessive moisture and thus deteriorate dimensional stability and cause great dimensional variation at high temperature. Accordingly, in high-temperature high-humidity nations (the Middle East, India and the like), disadvantageously, rotational torque is increased due to tooth shape change and performance is deteriorated.

In addition, after use for a long period of time, a gap between worm gear teeth and worm wheel gear teeth is increased by teeth abrasion, thus disadvantageously causing a rattling noise and thereby giving annoyance and thus unsatisfactory ride comfort to a driver.

### SUMMARY

Therefore, it is one aspect of the present invention to provide a reduction gear for electric power steering and a method for manufacturing the same which reduce an increase in rotational torque caused by resin expansion under high humidity environments and improve durability owing to superior frictional properties.

It is another aspect of the present invention to provide a reduction gear for electric power steering and a method for manufacturing the same which provide light steering feel upon low-speed driving and a heavy steering feel upon high-speed driving and thereby provide optimum steering conditions to a driver.

Additional aspects of the invention will be set forth in part in the description which follows and, in part, will be obvious from the description, or may be learned by practice of the invention.

In accordance with one aspect of the present invention, a reduction gear for electric power steering includes a first reduction gear composition for electric power steering containing 95 to 97 parts by weight of polyamide 66 (PA66) among polyamide-based materials, and a second reduction gear composition for electric power steering containing 3 to 5 parts by weight of an ethylene-methacrylic acid copolymer (EMAA) among polyolefin-based materials, wherein a weight ratio of the polyamide 66 (PA66) to the ethylene-methacrylic acid copolymer (EMAA) is 24:1 to 49:1.

In accordance with another aspect of the present invention, a reduction gear for electric power steering includes a first reduction gear composition for electric power steering containing 95 to 97 parts by weight of polyamide 66 (PA66) among polyamide-based materials, and a third reduction gear composition for electric power steering containing 3 to 5 parts by weight of linear low-density polyethylene (LLDPE) among polyolefin-based materials, wherein a weight ratio of the polyamide 66 (PA66) and the linear low-density polyethylene (LLDPE) is 24:1 to 49:1.

In accordance with another aspect of the present invention, a reduction gear for electric power steering includes a first reduction gear composition for electric power steering containing 95 to 97 parts by weight of polyamide 66 (PA66) among polyamide-based materials, and a fourth reduction gear composition for electric power steering containing 3 to 5 parts by weight of ethylene vinyl acetate (EVA) among polyolefin-based materials, wherein a weight ratio of the polyamide 66 (PA66) and the ethylene vinyl acetate (EVA) is 24:1 to 49:1.

In accordance with another aspect of the present invention, a method for manufacturing a reduction gear for electric power steering includes adding a first reduction gear composition for electric power steering containing 95 to 97 parts by weight of polyamide 66 (PA66) among polyamide-based materials and a second reduction gear composition for electric power steering containing 3 to 5 parts by weight of an ethylene-methacrylic acid copolymer (EMAA) among polyolefin-based materials to a heater having a melting temperature of 250° C. to 260° C. for 2 to 3 minutes, to prepare a mix composition containing the polyamide 66 (PA66) and the ethylene-methacrylic acid copolymer (EMAA) in a weight ratio of 24:1 to 49:1, injecting a material containing the mix composition using an injector at 270° C. to 280° C., and cooling the injected material containing the mix composition at room temperature.

In accordance with another aspect of the present invention, a method for manufacturing a reduction gear for electric power steering includes adding a first reduction gear composition for electric power steering containing 95 to 97 parts by weight of polyamide 66 (PA66) among polyamide-based materials and a third reduction gear composition for electric power steering containing 3 to 5 parts by weight of linear low-density polyethylene (LLDPE) among polyolefin-based materials to a heater having a melting temperature of 250° C. to 260° C. for 2 to 3 minutes, to prepare a mix composition containing the polyamide 66 (PA66) and the linear low-density polyethylene (LLDPE) in a weight ratio of 24:1 to 49:1, injecting a material containing the mix composition using an injector at 270° C. to 280° C., and cooling the injected material containing the mix composition at room temperature.

In accordance with another aspect of the present invention, a method for manufacturing a reduction gear for electric power steering includes adding a first reduction gear composition for electric power steering containing 95 to 97 parts by weight of polyamide 66 (PA66) among polyamide-based materials and a fourth reduction gear composition for electric power steering containing 3 to 5 parts by weight of ethylene vinyl acetate (EVA) among polyolefin-based materials to a heater having a melting temperature of 250° C. to 260° C. for 2 to 3 minutes, to prepare a mix composition containing the polyamide 66 (PA66) and the ethylene vinyl acetate (EVA) in a weight ratio of 24:1 to 49:1, injecting a material containing the mix composition using an injector at 270° C. to 280° C., and cooling the injected material containing the mix composition at room temperature.

### DETAILED DESCRIPTION

Hereinafter, embodiments of the present invention will be described in detail.

### First Embodiment

The reduction gear for electric power steering according to the first embodiment of the present invention includes a first reduction gear composition for electric power steering containing 95 to 97 parts by weight of polyamide 66 (PA66) among polyamide-based materials.

In addition, the reduction gear for electric power steering according to the first embodiment includes a second reduction gear composition for electric power steering containing 3 to 5 parts by weight of an ethylene-methacrylic acid copolymer (EMAA) among polyolefin-based materials.

Regarding the reduction gear for electric power steering according to the first embodiment, the polyamide 66 (PA66) and the ethylene-methacrylic acid copolymer (EMAA) are present in a weight ratio of 24:1 to 49:1.

TABLE 1

| | Tensile | Elonga- | | Moisture | Abrasion |
|---|---|---|---|---|---|
| | strength | tion | Hardness | absorption | depth |
| Material | (kgf/cm²) | (%) | (HRM) | (%) | (mm) |
| PA66 | 824 | 43 | 82 | 1.5 | 0.12 |
| PA66(97%) + | 724 | 49 | 79 | 1.0 | 0.06 |
| EMAA(3%) | | | | | |
| PA66(95%) + | 690 | 45 | 76 | 1.0 | 0.08 |
| EMAA(5%) | | | | | |
| PA66(90%) + | 667 | 49 | 66 | 1.0 | 0.23 |
| EMAA10% | | | | | |

A PA66 material has a high viscosity of 230 cm³/g or more and tensile strength, elongation, and hardness, moisture absorption and abrasion depth properties of the PA66 material, and materials containing PA66 and EMAA containing zinc are measured.

Here, tensile strength and hardness properties of PA66(97%)+EMAA(3%) and PA66(95%)+EMAA(5%) materials are poorer than those of a PA66 material, but elongation, moisture absorption and abrasion depth properties of the PA66(97%)+EMAA(3%) and PA66(95%)+EMAA(5%) materials are better than those of the PA66 material.

Moisture absorption of the PA66(95%)+EMAA(5%) material is equivalent to that of the PA66(97%)+EMAA(3%) material, but tensile strength, elongation, hardness and abrasion depth properties of the PA66(95%)+EMAA(5%) material are poorer than those of the PA66(97%)+EMAA(3%) material.

Meanwhile, moisture absorption of the PA66(95%)+EMAA(10%) material is equivalent to that of PA66(97%)+EMAA(3%) and PA66(95%)+EMAA(5%) materials.

In addition, elongation of the PA66(95%)+EMAA(10%) material is equivalent to that of the PA66(97%)+EMAA(3%) material.

On the other hand, tensile strength, hardness and abrasion depth properties of the PA66(95%)+EMAA(10%) material are poorer than those of the PA66(97%)+EMAA(3%) and PA66(95%)+EMAA(5%) materials.

Consequently, regarding the reduction gear for electric power steering according to the first embodiment, as a result of measurement of dimensional variation of worm wheel gears manufactured using the PA66-based material and the PA66+EMAA(1˜10%) material, respectively, until the worm wheel gears are saturated after being allowed to stand under moisture, it can be seen that moisture absorption of the PA66+EMAA (1-10%) material is better than that of the PA66-based material.

In addition, regarding wear resistance of the reduction gear for electric power steering according to the first embodiment, the PA66-based material and the PA66+EMAA (1-10%) material are processed into blocks using a block-on-ring friction abrasion tester, the blocks are operated together with rings made of the same material as a worm gear, and abrasion level and friction factor are measured. As a result, it can be seen that wear resistance of the PA66+EMAA (1˜10%) material is equivalent to that of the PA66-based material.

In addition, in order to measure performance of the reduction gear for electric power steering according to the first embodiment, worm wheel gears are manufactured using the PA66-based material and the PA66+EMAA (1˜10%) material, and deceleration durability testing and variation in rotational torque caused by moisture absorption are measured. As can be seen from the results, the PA66+EMAA1˜10% materials are applicable as worm wheel materials of the reduction gear.

A method for manufacturing the reduction gear for electric power steering according to the first embodiment will be described below.

The method for manufacturing the reduction gear for electric power steering according to the first embodiment includes adding a first reduction gear composition for electric power steering containing 95 to 97 parts by weight of polyamide 66 (PA66) among polyamide-based materials and a second reduction gear composition for electric power steering containing 3 to 5 parts by weight of an ethylene-methacrylic acid copolymer (EMAA) among polyolefin-based materials to a heater having a melting temperature of 250° C. to 260° C. for 2 to 3 minutes, to prepare a mix composition containing the polyamide 66 (PA66) and the ethylene-methacrylic acid copolymer (EMAA) in a weight ratio of 24:1 to 49:1, injecting a material containing the mix composition using an injector at 270° C. to 280° C., and cooling the injected material containing the mix composition at room temperature.

### Second Embodiment

The reduction gear for electric power steering according to the second embodiment of the present invention includes a first reduction gear composition for electric power steering containing 95 to 97 parts by weight of polyamide 66 (PA66) among polyamide-based materials.

In addition, the reduction gear for electric power steering according to the second embodiment includes a third reduction gear composition for electric power steering containing 3 to 5 parts by weight of linear low-density polyethylene (LLDPE) among polyolefin-based materials.

Regarding the reduction gear for electric power steering according to the second embodiment, the polyamide 66 (PA66) and the linear low-density polyethylene (LLDPE) are present in a weight ratio of 24:1 to 49:1.

TABLE 2

| | Tensile | Elonga- | | Moisture | Abrasion |
|---|---|---|---|---|---|
| | strength | tion | Hardness | absorption | depth |
| Material | (kgf/cm²) | (%) | (HRM) | (%) | (mm) |
| PA66 | 824 | 43 | 2 | 1.5 | 0.12 |
| PA66(97%) + | 724 | 49 | 9 | 1.0 | 0.06 |
| EMAA(3%) | | | | | |
| PA66(97%) + | 681 | 22 | 6 | 1.0 | 0.10 |
| LLDPE(3%) | | | | | |

A PA66 material has a high viscosity of 230 cm³/g or more and tensile strength, elongation, hardness, moisture absorption and abrasion depth properties of PA66, PA66(97%)+EMAA(3%) and PA66(97%)+LLDPE(3%) materials are measured.

Tensile strength, elongation and hardness properties of the PA66(97%)+LLDPE(3%) material are poorer than those of the PA66 material and PA66(97%)+EMAA(3%) material, but moisture absorption and abrasion depth properties of the PA66(97%)+LLDPE(3%) material are better than those of the PA66 material.

Abrasion depth of the PA66(97%)+LLDPE(3%) material is poorer than that of the PA66(97%)+EMAA(3%) material, but moisture absorption of the PA66(97%)+LLDPE(3%) material is equivalent to that of the PA66(97%)+EMAA(3%) material.

Consequently, regarding the reduction gear for electric power steering according to the second embodiment, as a result of measurement of dimensional variation of worm wheel gears manufactured using the PA66-based material and the PA66+LLDPE(1˜10%) material, respectively, until the worm wheel gears are saturated after being allowed to stand under moisture, it can be seen that moisture absorption of the PA66+LLDPE(1˜10%) material is better than that of the PA66-based material.

In addition, regarding wear resistance of the reduction gear for electric power steering according to the second embodiment, the PA66-based material and the PA66+LLDPE(1˜10%) material are processed into blocks using a block-on-ring friction abrasion tester, the blocks are operated together with rings made of the same material as a worm gear and abrasion level and friction factor are measured. As a result, wear resistance of the PA66+LLDPE(1˜10%) material is found to be equivalent to that of PA66-based material.

In addition, in order to measure performance of the reduction gear for electric power steering according to the second embodiment, worm wheel gears are manufactured using the PA66-based material and the PA66+LLDPE(1˜10%) material, deceleration durability test and variation in rotational torque caused by moisture absorption are measured. As can be seen from the results, the PA66+LLDPE (1˜10%) material is applicable as a worm wheel material of the reduction gear.

A method for manufacturing the reduction gear for electric power steering according to the second embodiment will be described below.

The method for manufacturing the reduction gear for electric power steering according to the second embodiment includes adding a first reduction gear composition for electric power steering containing 95 to 97 parts by weight of polyamide 66 (PA66) among polyamide-based materials and a third reduction gear composition for electric power steering containing 3 to 5 parts by weight of linear low-density polyethylene (LLDPE) among polyolefin-based materials to a heater having a melting temperature of 250° C. to 260° C. for 2 to 3 minutes, to prepare a mix composition containing the polyamide 66 (PA66) and the linear low-density polyethylene (LLDPE) in a weight ratio of 24:1 to 49:1, injecting a material containing the mix composition using an injector at 270° C. to 280° C., and cooling the injected material containing the mix composition at room temperature.

### Third Embodiment

The reduction gear for electric power steering according to the third embodiment of the present invention includes a first reduction gear composition for electric power steering containing 95 to 97 parts by weight of polyamide 66 (PA66) among polyamide-based materials.

In addition, the reduction gear for electric power steering according to the third embodiment includes a fourth reduction gear composition for electric power steering containing 3 to 5 parts by weight of ethylene vinyl acetate (EVA) among polyolefin-based materials.

Regarding the reduction gear for electric power steering according to the third embodiment, the polyamide 66 (PA66) and the ethylene vinyl acetate (EVA) are present in a weight ratio of 24:1 to 49:1.

TABLE 3

| | Tensile | Elonga- | | Moisture | Abrasion |
|---|---|---|---|---|---|
| | strength | tion | Hardness | absorption | depth |
| Material | (kgf/cm²) | (%) | (HRM) | (%) | (mm) |
| PA66 | 824 | 43 | 82 | 1.5 | 0.12 |
| PA66(97%) + | 724 | 49 | 79 | 1.0 | 0.06 |
| EMAA(3%) | | | | | |
| PA66(97%) + | 662 | 32 | 76 | 1.0 | 0.09 |
| EVA(3%) | | | | | |

A PA66 material has a high viscosity of 230 cm³/g or more and tensile strength, elongation, hardness, moisture absorption and abrasion depth properties of PA66, PA66(97%)+EMAA(3%) and PA66(97%)+EVA(3%) materials are measured.

Tensile strength, elongation and hardness properties of the PA66(97%)+EVA(3%) material are poorer than those of the PA66 material and the PA66(97%)+EMAA(3%) material, but moisture absorption and abrasion depth properties of the PA66(97%)+EVA(3%) material are better than those of the PA66 material.

An abrasion depth property of the PA66(97%)+EVA(3%) material is poorer than that of the PA66(97%)+EMAA(3%) material, but a moisture absorption property of the PA66(97%)+EVA(3%) material is equivalent to that of the PA66(97%)+EMAA(3%) material.

Consequently, regarding the reduction gear for electric power steering according to the third embodiment, as a result of measurement of dimensional variation of worm wheel gears manufactured using the PA66-based material and the PA66+EVA(1˜10%) material, respectively, until the worm wheel gears are saturated after being allowed to stand under moisture, it can be seen that moisture absorption of the PA66+EVA(1˜10%) material is better than that of the PA66-based material.

In addition, regarding wear resistance of the reduction gear for electric power steering according to the third embodiment, the PA66-based material and the PA66+EVA(1-10%) material are processed into blocks using a block-on-ring friction abrasion tester, the blocks are operated together with rings made of the same material as a worm gear and abrasion level and friction factor are measured. As a result, wear resistance of the PA66+EVA(1˜10%) material is found to be equivalent to that of PA66-based material.

In addition, in order to measure performance of the reduction gear for electric power steering according to the third embodiment, worm wheel gears are manufactured using the PA66-based material and the PA66+EVA(1˜10%) material, deceleration durability testing and variation in rotational torque caused by moisture absorption are measured. As can be seen from the results, the PA66+EVA (1˜10%) material is applicable as a worm wheel material of the reduction gear.

A method for manufacturing the reduction gear for electric power steering according to the third embodiment will be described below.

The method for manufacturing the reduction gear for electric power steering according to the third embodiment includes adding a first reduction gear composition for electric power steering containing 95 to 97 parts by weight of polyamide 66 (PA66) among polyamide-based materials and a fourth reduction gear composition for electric power steering containing 3 to 5 parts by weight of ethylene vinyl acetate (EVA) among polyolefin-based materials to a heater having a melting temperature of 250° C. to 260° C. for 2 to 3 minutes, to prepare a mix composition containing the polyamide 66 (PA66) and the ethylene vinyl acetate (EVA) in a weight ratio of 2 :1 to 49:1, injecting a material containing the mix composition using an injector at 270° C. to 280° C., and cooling the injected material including the mix composition at room temperature.

The reduction gear for electric power steering and the method for manufacturing the same according to the third embodiment have the following effects.

First, the reduction gear for electric power steering and the method for manufacturing the same have an effect of reducing an increase in rotational torque caused by resin expansion under high humidity environments and thereby improving durability owing to superior durability.

Second, the reduction gear for electric power steering and the method for manufacturing the same have another effect of providing light steering feel upon low-speed driving and a heavy steering feel upon high-speed driving and thereby providing optimal steering conditions.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A reduction gear for electric power steering comprising:
a first reduction gear composition for electric power steering comprising 95 to 97 parts by weight of polyamide 66 (PA66) among polyamide-based materials; and
a second reduction gear composition for electric power steering comprising 3 to 5 parts by weight of an ethylene-methacrylic acid copolymer (EMAA) among polyolefin-based materials,
wherein a weight ratio of the polyamide 66 (PA66) to the ethylene-methacrylic acid copolymer (EMAA) is 24:1 to 49:1.

2. A reduction gear for electric power steering comprising:
a first reduction gear composition for electric power steering comprising 95 to 97 parts by weight of polyamide 66 (PA66) among polyamide-based materials; and
a third reduction gear composition for electric power steering comprising 3 to 5 parts by weight of linear low-density polyethylene (LLDPE) among polyolefin-based materials,
wherein a weight ratio of the polyamide 66 (PA66) and the linear low-density polyethylene (LLDPE) is 24:1 to 49:1.

3. A reduction gear for electric power steering comprising:
a first reduction gear composition for electric power steering comprising 95 to 97 parts by weight of polyamide 66 (PA66) among polyamide-based materials; and
a fourth reduction gear composition for electric power steering comprising 3 to 5 parts by weight of ethylene vinyl acetate (EVA) among polyolefin-based materials, wherein a weight ratio of the polyamide 66 (PA66) and the ethylene vinyl acetate (EVA) is 24:1 to 49:1.

4. A method for manufacturing a reduction gear for electric power steering comprising:
adding a first reduction gear composition for electric power steering comprising 95 to 97 parts by weight of polyamide 66 (PA66) among polyamide-based materials and a second reduction gear composition for electric power steering comprising 3 to 5 parts by weight of an ethylene-methacrylic acid copolymer (EMAA) among polyolefin-based materials to a heater having a melting temperature of 250° C. to 260° C. for 2 to 3 minutes, to prepare a mix composition comprising the polyamide 66 (PA66) and the ethylene-methacrylic acid copolymer (EMAA) in a weight ratio of 24:1 to 49:1;
injecting a material comprising the mix composition using an injector at 270° C. to 280° C.; and
cooling the injected material comprising the mix composition at room temperature.

5. A method for manufacturing a reduction gear for electric power steering comprising:
adding a first reduction gear composition for electric power steering comprising 95 to 97 parts by weight of polyamide 66 (PA66) among polyamide-based materials and a third reduction gear composition for electric power steering comprising 3 to 5 parts by weight of linear low-density polyethylene (LLDPE) among polyolefin-based materials to a heater having a melting temperature of 250° C. to 260° C. for 2 to 3 minutes, to prepare a mix composition comprising the polyamide 66 (PA66) and the linear low-density polyethylene (LLDPE) in a weight ratio of 24:1 to 49:1;
injecting a material comprising the mix composition using an injector at 270° C. to 280° C.; and
cooling the injected material comprising the mix composition at room temperature.

6. A method for manufacturing a reduction gear for electric power steering comprising:
adding a first reduction gear composition for electric power steering comprising 95 to 97 parts by weight of polyamide 66 (PA66) among polyamide-based materials and a fourth reduction gear composition for electric power steering comprising 3 to 5 parts by weight of ethylene vinyl acetate (EVA) among polyolefin-based materials to a heater having a melting temperature of 250° C. to 260° C. for 2 to 3 minutes, to prepare a mix composition comprising the polyamide 66 (PA66) and the ethylene vinyl acetate (EVA) in a weight ratio of 24:1 to 49:1;
injecting a material comprising the mix composition using an injector at 270° C. to 280° C.;
and cooling the injected material comprising the mix composition at room temperature.
